(19) United States
(12) Patent Application Publication
(10) Pub. No.: US 2013/0093178 A1
(43) Pub. Date: Apr. 18, 2013

(54) MULTI-LAYERED LABEL FOR A LETTER OR PACKAGE

(71) Applicants: Ted Shanley, Freeland, WA (US); Dan VanWaveren, Snohomish, WA (US)

(72) Inventors: Ted Shanley, Freeland, WA (US); Dan VanWaveren, Snohomish, WA (US)

(73) Assignee: Emerald City Label, Inc., Everett, WA (US)

(21) Appl. No.: 13/706,702

(22) Filed: Dec. 6, 2012

Related U.S. Application Data
(63) Continuation-in-part of application No. 13/048,166, filed on Mar. 15, 2011.
(60) Provisional application No. 61/317,363, filed on Mar. 25, 2010.

(51) Int. Cl. B42D 15/00

(52) U.S. Cl. CPC B42D 15/00
USPC 283/81

(57) ABSTRACT

A label includes a first panel and a second panel that is attached to the first panel. The first panel includes a third panel. The third panel includes one or more sides that are detachable from the first panel.

This application is a continuation-in-part of U.S. patent application Ser. No. 13/048,166, filed on Mar. 15, 2011, which claims the benefit of priority under 35 U.S.C. 119(e) to U.S. Provisional Patent Application Ser. No. 61/317,363, filed on Mar. 25, 2010, both of which are incorporated herein by reference in their entireties.

### BACKGROUND

Labels are generally applied to letters and packages for a variety of purposes. For example, the label may include information about the contents of a letter or package, or it may include information about an addressee of the letter or the package.

### BRIEF DESCRIPTION OF THE FIGURES

FIG. 1 is a diagrammatic view of a multi-layered label, according to the various embodiments.

FIG. 2 is another diagrammatic view of the multi-layered label of FIG. 1, according to the various embodiments.

FIG. 3 is still another diagrammatic view of the multi-layered label of FIG. 1, according to the various embodiments.

FIG. 4 is still another diagrammatic view of the multi-layered label of FIG. 1, according to the various embodiments.

FIG. 5 is a plan view of an underside of the multi-layered label, according to the various embodiments.

FIG. 6 is a partial isometric view of the underside of the multi-layered label, according to the various embodiments.

FIG. 7 is another partial isometric view of the underside of the multi-layered label, according to the various embodiments.

### DETAILED DESERIPTION

In the following description, reference may be made to the accompanying drawings that form a portion of the present disclosure, and show by way of illustration, various embodiments that may be practiced. Although the various embodiments are described in sufficient detail to permit those skilled in the art to practice the various embodiments, still other embodiments may be possible through various structural changes without departing from the scope of the present disclosure.

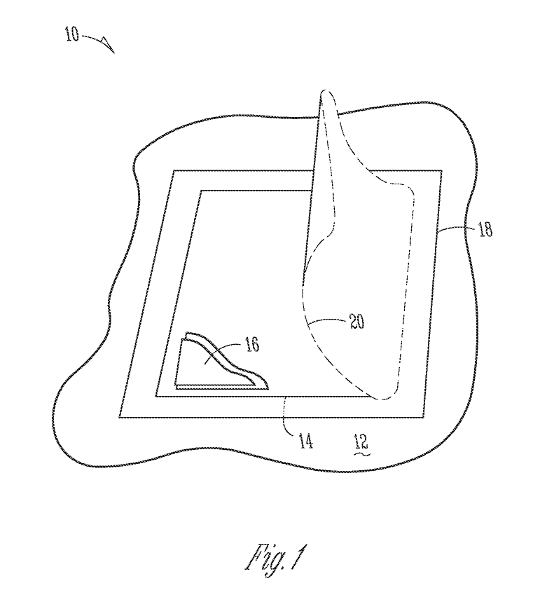

FIG. 1 is a diagrammatic view of a multi-layer label 10, according to the various embodiments. The label 10 may be configured to be positioned on a surface 12 of a letter, a package or parcel, or other similar articles. The label 10 may be configured to be adhesively attached to the surface 12 using a standard adhesive material and backing combination. Accordingly, the label 10 may include an adhesive material 14 that is concealed by a backing material (not shown in FIG. 1) that may be removed to expose the adhesive material 14 prior to affixing the label 10 to the surface 12. Alternatively, the adhesive material 14 may be activated by the introduction of moisture to the adhesive material 14 (e.g., a gummed backing) Alternatively, the adhesive material 14 may be applied to the label 10 by brushing, spraying, or rolling a suitable adhesive onto the label 10, or onto the surface 12 prior to positioning the label 10 onto the surface 12. The label 10 may also include one or more panels 16 that may be concealed beneath an external panel 18. The external panel 18 may also include a detachable panel 20 that may be configured to be at least partially separable from the external panel 18, so that the one or more panels 16 may be exposed after the label 10 is applied to the surface 12. The one or more panels 16, the external panel 18 and the detachable panel 20 will be discussed in greater detail below.

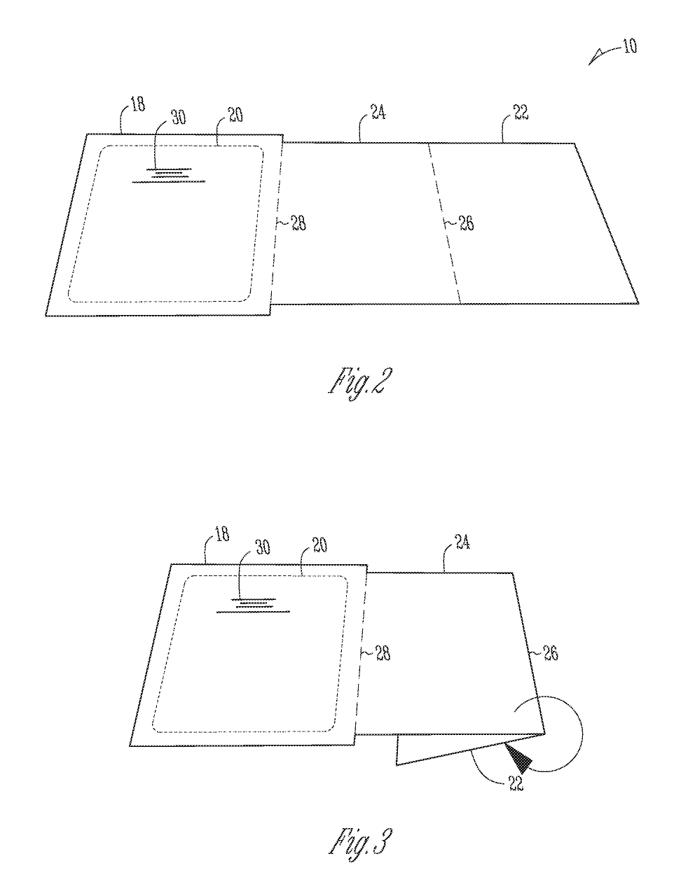

FIG. 2 is another diagrammatic view of the label 10 of FIG. 1, according to the various embodiments. The label 10 may include a first panel 22 and a second panel 24 hingeably attached to the first panel 22 by a fold line 26. The second panel 24 may be further attached to the external panel 18 by a scored line 28. The scored line 28 will be discussed in detail below. The first panel 22 and the second panel 24 may be configured to include various written and/or graphical representations, including promotional information for various commercial products and/or services, and may be further configured to include a personalized message. In accordance with an embodiment, at least a portion of the first panel 22 may include a personalized message that may be directly viewed when the detachable panel 20 is at least partially removed from the external panel 18. In accordance with another embodiment, the first panel 22 may be omitted, so that only a single panel (e.g., the second panel 24) may be concealed by the external panel 18. In accordance with another embodiment, additional hingeably attached panels can be coupled to either the first panel 22 and/or the second panel 24.

Still referring to FIG. 2, the detachable panel 20 of the external panel 18 may also be configured to include various written and/or graphical information 30. For example, the written and/or graphical information 30 may include an identification of an addressor (e.g., a shipper, or a sender), an addressee (e.g., a recipient), or other pertinent information, such as information provided by a carrier that handles the shipping of the item attached to the label 10. The written and/or graphical information 30 may therefore include written (e.g., plain language) information and it may also include coded information in various forms, such as one-dimensional or two-dimensional bar code information, for example.

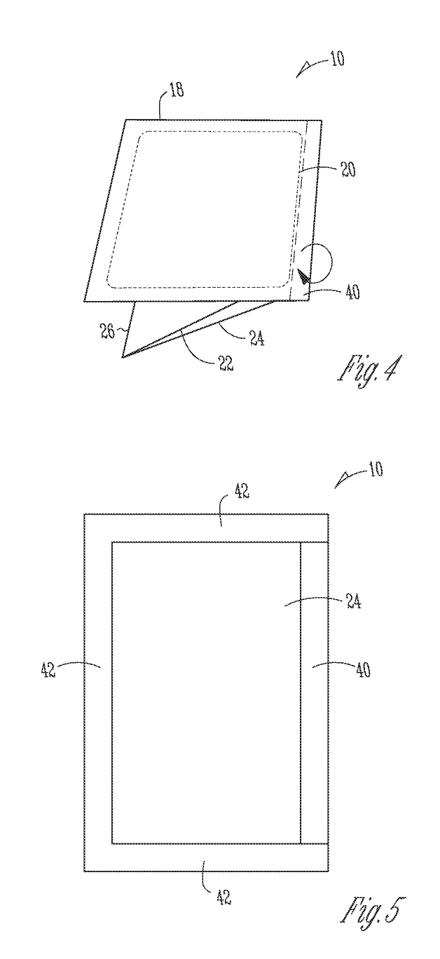

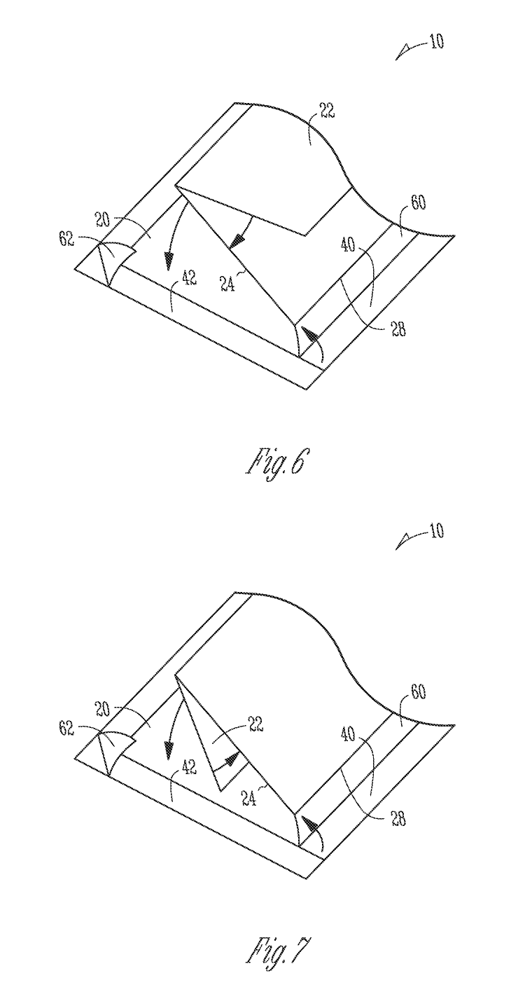

Referring now to FIG. 3, and prior to attaching the label 10 to the surface 12 (as shown in FIG. 1), the first panel 22 of the label 10 may be configured to be rotated about the fold line 26 and towards an underside of the second panel 24. The first panel 22 could also be rotated in a direction opposite that shown in FIG. 3 (See FIG. 6). Turning now to FIG. 4, the first panel 22 and the second panel 24 may be rotated in unison, as shown, to abut an underside of the detachable panel 20. The first panel 22 and the second panel 24 may be substantially aligned with the detachable panel 20 following the rotation shown in FIG. 4. As the first panel 22 and the second panel 24 are rotated, a first adhesive portion 40 of the adhesive material 14 may be exposed by the removal of the backing material from the adhesive material 14.

FIG. 5 is a plan view of an underside of the label 10, according to the various embodiments. Since the first panel 22 and the second panel 24 are rotated to an underside of the label 10, as discussed in connection with FIG. 4, the first adhesive portion 40 is exposed and is prepared to be applied to the surface 12 (as shown in FIG. 1) Prior to application of the label 10 to the surface, a second adhesive portion 42 may be removed from the underside of the label 10, whereupon the label 10 may be adhesively attached to the surface 12.

With reference now to FIGS. 6 and 7, partial isometric views of the underside of the label 10 are shown that will be used to further describe the first adhesive portion 40, according to the various embodiments. The scored line 28 may be configured to be pulled away from the first adhesive portion 40, so that the first panel 22 and the second panel 24 remain attached to the label 10 by a backing material 60 as the first panel 22 and the second panel 24 are rotated into contact with an underside of the detachable panel 20. The backing material 62 may also be removed from the second adhesive portion 42, so that the first adhesive portion 40 and the second adhesive portion 42 cooperatively adhere the label 10 to the surface 12 (as shown in FIG. 1).

### Example Embodiments

Example No. 1 is a label that includes a first panel and a second panel. The second panel is attached to the first panel. The first panel includes a third panel, and the third panel includes one or more sides that are detachable from the first panel.

Example No. 2 may include the features of Example No. 1, and optionally includes a label wherein the second panel is detachable from the first panel.

Example No. 3 may include the features of Example Nos. 1-2, and optionally includes a label wherein the third panel is substantially centered within an area of the first panel, and wherein the third panel and first panel are configured such that three sides of the third panel are detachable from the first panel, while a fourth side of the third panel remains attached to the first panel, thereby permitting the third panel to rotate or pivot about a line formed by the fourth side and the first panel.

Example No. 4 may include the features of Examples Nos. 1-3, and optionally includes a label wherein the fourth side of the third panel is detachable from the first panel.

Example No. 5 may include the features of Examples Nos. 1-4, and optionally includes a label including an adhesive on an underside of the first panel.

Example No. 6 may include the features of Examples Nos. 1-5, and optionally includes a label including an adhesive on an underside of the second panel.

Example No. 7 may include the features of Examples Nos. 1-6, and optionally includes a label including a peelable covering over the adhesive on the underside of the first panel and a peelable covering over the adhesive on the underside of the second panel.

Example No. 8 may include the features of Examples Nos, 1-7, and optionally includes a label wherein the first panel includes an adhesive portion at a point of attachment between the first panel and the second panel such that upon rotating or pivoting the second panel about the point of attachment, the second panel separates from the first panel and exposes an underside of the adhesive portion, wherein the underside of the adhesive portion comprises an adhesive.

Example No. 9 may include the features of Examples Nos. 1-8, and optionally includes a label wherein the first panel and second panel are configured such that upon rotating or pivoting the second panel, the second panel is positioned adjacent to the underside of the first panel, and the sides of the third panel are configured such that a removal of the third panel from the first panel exposes the second panel.

Example No. 10 may include the features of Examples Nos. 1-9, and optionally includes a label wherein the first panel includes a perimeter around the third panel, such that when the second panel is positioned adjacent the underside of the first panel, the perimeter outlines the second panel.

Example No. 11 may include the features of Examples Nos. 1-10, and optionally includes a label wherein the one or more sides of the third panel are coupled to the first panel via a perforated edge.

Example No. 12 may include the features of Examples Nos, 1-11, and optionally includes a label wherein the label is configured for attachment to a letter, package, or other parcel.

Example No. 13 may include the features of Examples Nos. 1-12, and optionally includes a label including a fourth panel attached to the second panel.

Example No. 14 may include the features of Examples Nos, 1-13, and optionally includes a label wherein one or more of the second panel and the fourth panel comprise one or more of a promotional message, a commercial message, an advertizing message, a personal message, and a return mailing label.

Example No. 15 may include the features of Examples Nos. 1-14, and optionally includes a label wherein the third panel is detachable from the second panel on a side that is opposite the side at which the second panel is attached to the first panel.

Example No. 16 may include the features of Examples Nos. 1-15, and optionally includes a label wherein the second panel is attached to the first panel via a score line.

Example No. 17 may include the features of Examples Nos. 1-16, and optionally includes a label wherein the third panel is attached to the second panel via a fold line.

Example No. 18 may include the features of Examples Nos. 1-17, and optionally includes a label wherein the second panel and the fourth panel are configured such that upon rotating or pivoting the fourth panel about the fold line, and upon rotating or pivoting the second panel about the score line, the second panel and the third panel are positioned adjacent to the underside of the first panel, and the sides of the third panel are configured such that a removal of the third panel from the first panel exposes the second panel and the fourth panel, and wherein the first panel comprises a perimeter around the third panel such that when the second panel and fourth panel are positioned adjacent to the underside of the first panel, the perimeter outlines the second panel and the fourth panel.

Example No. 19 may include the features of Examples Nos. 1-18, and optionally includes a label wherein upon positioning the second panel and the fourth panel adjacent to the underside of the first panel, the adhesive portion adjacent to the score line is exposed, the adhersive portion comprising an adhesive on an underside of the adhesive portion.

Example No. 20 may include the features of Examples Nos. 1-19, and optionally includes a label including a perimeter around the first panel, the perimeter comprising an adhesive on an underside of the perimeter.

Example No. 21 may include the features of Examples Nos, 1-20, and optionally includes a label wherein the first panel comprises one or more of addressor information, addressee information, shipper information, and a computer readable code such as a one or two dimensional bar code.

Example No. 22 is a label that includes a first panel, and a second panel that is detachably coupled to the first panel. The first panel includes a third panel, and the third panel includes one or more sides that are detachable from the first panel. The third panel is substantially centered within an area of the first panel. The first panel includes an adhesive portion at a point of attachment between the first panel and the second panel such that upon rotating or pivoting the second panel about the point of attachment, the second panel separates from the first panel and exposes an underside of the adhesive portion. The underside of the adhesive portion comprises an adhesive. The first panel and second panel are configured such that upon rotating or pivoting the second panel, the second panel is positioned adjacent to the underside of the first panel, and the sides of the third panel are configured such that a removal of the third panel from the first panel exposes the second panel.

Example No. 23 may include the features of Examples No. 22, and optionally includes a label including an adhesive on an underside of the first panel and an adhesive on an underside of the second panel.

Example No. 24 may include the features of Examples Nos. 22-23, and optionally includes a label including a fourth panel attached to the second panel.

Example No. 25 may include the features of Examples Nos, 22-24, and optionally includes a label wherein the fourth panel is detachable from the second panel on a side that is opposite the side at which the second panel is attached to the first panel.

Example No. 26 may include the features of Examples Nos. 22-25, and optionally includes a label wherein the second panel is attached to the first panel via a score line.

Example No. 27 may include the features of Examples Nos. 22-26, and optionally includes a label wherein the fourth panel is attached to the second panel via a fold line.

Example No. 28 may include the features of Examples Nos. 22-27, and optionally includes a label wherein the second panel and the fourth panel are configured such that upon rotating or pivoting the fourth panel about the fold line, and upon rotating or pivoting the second panel about the score line, the second panel and the fourth panel are positioned adjacent to an underside of the first panel. The sides of the third panel are configured such that a removal of the third panel from the first panel exposes the second panel and the fourth panel, The first panel includes a perimeter around the third panel such that when the second panel and fourth panel are positioned adjacent to the underside of the first panel, the perimeter outlines the second panel and the fourth panel.

While the various embodiments have been illustrated and described, as noted above, this Detailed Description is not to be taken in a limiting sense. Instead, this disclosure is intended to cover adaptations or variations of the various embodiments. Combinations of the various embodiments, and other embodiments not specifically described herein, will be apparent to those of ordinary skill in the art upon reviewing the above description.

1. A label comprising:
a first panel; and
a second panel attached to the first panel;
wherein the first panel comprises a third panel, the third panel comprising one or more sides that are detachable from the first panel.

2. The label of claim 1, wherein the second panel is detachable from the first panel.

3. The label of claim 1, wherein the third panel is substantially centered within an area of the first panel, and wherein the third panel and first panel are configured such that three sides of the third panel are detachable from the first panel, while a fourth side of the third panel remains attached to the first panel, thereby permitting the third panel to pivot about a line formed by the fourth side and the first panel.

4. The label of claim 3, wherein the fourth side of the third panel is detachable from the first panel.

5. The label of claim 1, comprising an adhesive on an underside of the first panel.

6. The label of claim 5, comprising an adhesive on an underside of the second panel.

7. The label of claim 6, comprising a peelable covering over the adhesive on the underside of the first panel and a peelable covering over the adhesive on the underside of the second panel.

8. The label of claim 7, wherein the first panel comprises an adhesive portion at a point of attachment between the first panel and the second panel such that upon pivoting the second panel about the point of attachment, the second panel. separates from the first panel and exposes an underside of the adhesive portion, wherein the underside of the adhesive portion comprises the adhesive.

9. The label of claim 8, wherein the first panel and second panel are configured such that upon pivoting the second panel, the second panel is positioned adjacent to the underside of the first panel, and the sides of the third panel are configured such that a removal of the third panel from the first panel exposes the second panel.

10. The label of claim 9, wherein the first panel comprises a perimeter around the third panel, such that when the second panel is positioned adjacent the underside of the first panel, the perimeter outlines the second panel.

11. The label of claim 1, wherein the one or more sides of the third panel are coupled to the first panel via a perforated edge.

12. The label of claim 1, wherein the label is configured for attachment to a letter, package, or other parcel.

13. The label of claim 1, comprising a fourth panel attached to the second panel.

14. The label of claim 13, wherein one or more of the second panel and the fourth panel comprise one or more of a promotional message, a commercial message, an advertizing message, a personal message, and a return mailing label.

15. The label of claim 13, wherein the fourth panel is detachable from the second panel on a side that is opposite the side at which the second panel is attached to the first panel.

16. The label of claim 15, wherein the second panel is attached to the first panel via a scored line.

17. The label of claim 16, wherein the fourth panel is attached to the second panel via a fold line.

18. The label of claim 17, wherein the second panel and the fourth panel are configured such that upon pivoting the fourth panel about the fold line, and upon pivoting the second panel about the scored line, the second panel and the fourth panel are positioned adjacent to the underside of the first panel, and the sides of the third panel are configured such that a removal of the third panel from the first panel exposes the second panel and the fourth panel, and wherein the first panel comprises a perimeter around the third panel such that when the second panel and fourth panel are positioned adjacent to the underside of the first panel, the perimeter outlines the second panel and the fourth panel.

19. The label of claim 18, wherein upon positioning the second panel and the fourth panel adjacent to the underside of the first panel, an adhesive portion adjacent to the scored line is exposed, the adhesive portion comprising an adhesive on an underside of the adhesive portion.

20. The label of claim 19, comprising a perimeter around the first panel, the perimeter comprising an adhesive on an underside of the perimeter.

21. The label of claim 1, wherein the first panel comprises one or more of addressor information, addressee information, shipper information, and a computer readable code.

22. A label comprising:
a first panel; and
a second panel detachably coupled to the first panel;
wherein the first panel comprises a third panel, the third panel comprising one or more sides that are detachable from the first panel;
wherein the third panel is substantially centered within an area of the first panel;
wherein the first panel comprises an adhesive portion at a point of attachment between the first panel and the second panel such that upon pivoting the second panel about the point of attachment, the second panel separates from the first panel and exposes an underside of the adhesive portion, wherein the underside of the adhesive portion comprises the adhesive; and
wherein the first panel and second panel are configured such that upon pivoting the second panel, the second panel is positioned adjacent to the underside of the first panel, and the sides of the third panel are configured such that a removal of the third panel from the first panel exposes the second panel.

23. The label of claim 22, comprising an adhesive on an underside of the first panel and an adhesive on an underside of the second panel.

24. The label of claim 22, comprising a fourth panel attached to the second panel.

25. The label of claim 24, wherein the third panel is detachable from the second panel on a side that is opposite the side at which the second panel is attached to the first panel.

26. The label of claim 25, wherein the second panel is attached to the first panel via a. scored line.

27. The label of claim 26, wherein the fourth panel is attach to the second panel via a fold line.

28. The label of claim 27, wherein the second panel and the third panel are configured such that upon pivoting the fourth panel about the fold line, and upon pivoting the second panel about the scored line, the second panel and the fourth panel are positioned adjacent to an underside of the first panel; and the sides of the third panel are configured such that a removal of the third panel from the first panel exposes the second panel and the fourth panel, and wherein the first panel comprises a perimeter around the third panel such that when the second panel and fourth panel are positioned adjacent to the underside of the first panel, the perimeter outlines the second panel and the fourth panel.
